(19) United States
(12) Patent Application Publication
(10) Pub. No.: US 2014/0311237 A1
(43) Pub. Date: Oct. 23, 2014

(54) METHOD FOR DETECTING A FLOW PROPERTY OF A FLOWING FLUID MEDIUM

(71) Applicant: ROBERT BOSCH GMBH, Stuttgart (DE)

(72) Inventors: Ulrich Wagner, Muenchen (DE); Uwe Konzelmann, Asperg (DE)

(21) Appl. No.: 14/346,571

(22) PCT Filed: Aug. 3, 2012
(86) PCT No.: PCT/EP2012/065296

§ 371 Date: Jul. 7, 2014

(30) Foreign Application Priority Data
Sep. 23, 2011 (DE) 10 2011 083 287.4

(51) Int. Cl. G01F 1/68; G01F 25/00

(52) U.S. Cl. CPC G01F 1/68; G01F 25/00
USPC 73/204.18

(57) ABSTRACT

A method for detecting at least one flow property of a flowing fluid medium, at least one sensor element being used. The sensor element includes at least one heating element and at least two temperature measuring sensors. At least one first measured variable and at least one second measured variable, which is different from the first measured variable, are detected with the aid of the sensor element. The first measured variable and the second measured variable may be influenced by the flow property. At least one correction, in particular at least one correction factor and/or at least one correction vector, is generated from the first measured variable and the second measured variable. The flow property is determined from the first measured variable and the second measured variable under consideration of the correction.

### FIELD OF THE INVENTION

The present invention is directed to devices and methods for detecting at least one flow property of a fluid medium, for example, a fluid medium flowing in a main flow direction through a flow pipe. The fluid medium may fundamentally be gases and/or liquids, in particular air, for example, intake air in an intake system of an internal combustion engine of a motor vehicle. However, other fields of application are also conceivable. The at least one flow property to be determined may fundamentally be an arbitrary physical and/or chemical parameter of the flowing fluid medium. In particular, the flow property may be a mass flow rate and/or a volume flow rate and/or an air mass flow, for example.

### BACKGROUND INFORMATION

For example, a thermal measuring method may be used for a flow measurement of intake air, in particular in the motor vehicle. The thermal measuring method is distinguished by direct detection of the flow property sought, in particular a measured variable, namely, for example, the air mass, by high dynamic response, and/or by a broad detection range of the air mass. The present invention is described hereafter, without restriction of further possible embodiments, in particular with reference to an air mass measurement, for example, in the intake system of an internal combustion engine. Numerous air flow meters, in particular thermal air flow meters, for example, hot-film air flow meters (HFM) 136 are discussed in the related art, for example, in Robert Bosch GmbH: Sensoren im Kraftfahrzeug [Sensors in Motor Vehicles], first edition 2010, pages 146 through 149. In particular, these devices may be so-called hot-film air flow meters, which are normally configured as plug-in sensors and which generally include at least one channel, through which at least one part of the flowing fluid medium is conducted. A sensor element, for example, a hot-film air flow meter chip (HFM chip) is generally situated in the channel, which includes at least one heating element and at least two temperature sensors situated respectively upstream and downstream of the heating element. The mass flow rate of the fluid medium, for example, the intake air, may be inferred from an asymmetry of a temperature distribution if a mass flow rate is present, in particular via the sensor element.

A device for determining the throughput of a flowing medium is discussed in DE 196 03 346 A1, a measuring voltage resulting as a consequence of a temperature difference being detected on a bridge diagonal of an analysis unit to determine the throughput, a heating voltage being constant or regionally constant, and the measuring voltage being analyzed in the analysis unit with the aid of at least one stored characteristic curve, which establishes a relationship between the measuring voltage and the throughput of the flowing medium.

A mass flow rate sensor is discussed in DE 43 24 040 B4, temperature measuring sensors being situated symmetrically to a heater, having an analysis arrangement, which form a sensor signal by measuring the signals of the temperature measuring sensors, and having a regulating arrangement, which regulate an excess temperature of the heater, i.e., the temperature difference in relation to the medium flow. The regulating arrangement regulates the temperature of the heater as a function of the temperature of the medium flow in such a way that the excess temperature becomes greater with increasing temperature of the medium flow.

A device for determining the throughput of a flowing medium is discussed in EP 0 859 943 B1, an improvement of the temperature behavior being achieved, in particular in that a circuit arrangement is supplemented by an additional resistor bridge circuit, this additional resistor bridge circuit allowing a high temperature compensation.

It is believed that devices and methods typically disadvantageously have a sensitivity in principle with respect to contamination of the sensor element. A change of the heat conduction and/or a change of the heat dissipation to the air and/or a change of the local flow around the sensor element may occur due to contamination of the sensor element, for example, whereby a change of the measuring signal may be caused, for example. A contamination of a diaphragm of the sensor element may result in corruption of the measuring signal depending on a location of the dirt deposit, for example.

Therefore, a reduction of an influence of contamination on the measuring signal of a thermal air flow meter would be desirable.

### SUMMARY OF THE INVENTION

Accordingly, a method and a device are provided for detecting at least one flow property of a flowing fluid medium. The flow property may in principle be an arbitrary chemical and/or physical property of the flowing fluid medium. In particular, it may be a mass flow rate and/or a volume flow rate of the fluid medium. The fluid medium may in general be one or more gases and/or liquids. The fluid medium may be intake air in a motor vehicle. In the method according to the present invention, at least one sensor element is used. The sensor element may generally be a device which may be used to detect the flow property of the flowing fluid medium. The sensor element includes at least one heating element and at least two temperature measuring sensors. The sensor element may be in particular an element which is configured to qualitatively and/or quantitatively detect the at least one flow property of the flowing fluid medium and/or to convert the flow property into suitable measuring signals, for example, in particular electrical and/or optical signals. In particular, the sensor element may include at least one sensor chip which may be brought into contact with the flowing fluid medium, for example, a hot-film air flow meter sensor chip. The sensor element may include at least one sensor chip having a measuring surface, for example. The sensor element and/or the device may be configured as an anemometer. The heating element may in principle be a device which is configured to heat at least one part of the sensor element, in particular to regulate at least one part of the sensor element to a certain preselected temperature. The heating element may be situated on the measuring surface, for example. The heating element may be at least one heating resistor, for example. The temperature measuring sensor may be in principle a device which is configured to detect at least one temperature, in particular a temperature of the sensor element. The two temperature measuring sensors may be, for example, at least two temperature measuring resistors, which may be situated on the measuring surface, as the heating element is also, for example.

At least one first measured variable and at least one second measured variable, which is different from the first measured variable, are detected with the aid of the sensor element. The first measured variable and/or the second measured variable may be in principle an arbitrary detectable property of the sensor element. The measured variable may be a chemical and/or physical measured variable, for example. The expression “different” may be understood to mean that the first measured variable is a different physical and/or chemical measured variable than the second measured variable.

The first measured variable and the second measured variable may be influenced by the flow property. The first measured variable and/or the second measured variable may be in particular electrical measured variables. The first measured variable and/or the second measured variable may each be a single measured value; they may be a measuring series, for example, including multiple measured values. In particular, the first measured variable and/or the second measured variable may be a measuring series with variation of a parameter, the parameter being able to be an arbitrary physical and/or chemical parameter, for example, the flow property of the flowing fluid medium. For example, the first measured variable and/or the second measured variable may also be an analysis of a measuring series. The first measured variable and/or the second measured variable may be, for example, a temperature difference and/or a temperature and/or an electrical voltage and/or a voltage difference and/or an electrical current and/or a current difference and/or an ohmic resistance and/or a resistance difference and/or a power and/or a power difference. The expression “may be influenced” may be understood in particular to mean that the first measured variable and/or the second measured variable changes, in particular detectably changes, if the flow property changes.

At least one correction, in particular at least one correction factor and/or at least one correction vector, is generated from the first measured variable and the second measured variable. A correction may be understood in principle as a computing method and/or a computing scheme. The correction may be used for the purpose of approximating a detected measured variable, for example, the flow property, in particular the first measured variable and/or the second measured variable, to a real flow property. In particular, the correction may be used to reduce measuring errors, for example, systematic errors, in particular systematic measuring errors, for example, in the detection of the flow property. Alternatively or additionally, the correction may be used to obtain and/or update and/or make more precise a calibration, for example, a calibration of the detection of the flow property. The expression “generate” may be understood in this case to mean that the correction may be obtained by calculating and/or measuring and/or simulation and/or calibration, for example, in the new condition. The correction vector may be understood, for example, as a numeric, which may be dimensionless variable, which is established in the new condition, for example, which may be once, for example, with the aid of a calibration; in particular, multiple correction vectors may be stored for various flow properties, for example, in particular in a memory of the device. The correction vector may be selected from the memory depending on the first measured variable and/or the second measured variable during the method according to the present invention, for example.

The flow property is determined from the first measured variable and the second measured variable under consideration of the correction. The expression “determine under consideration” may be understood to mean, for example, that the correction is calculated and/or compensated using the first measured variable and/or the second measured variable.

A change of a state of a sensor element may influence the first measured variable and the second measured variable in different ways. The state may be at least one contamination and/or at least one soiling of at least one part of the sensor element and/or at least one temperature change of at least one part of the sensor element, for example. The change of the state may be a change of the contamination and/or the soiling and/or the location of the contamination and/or the location of the soiling, for example. The expression “influence in different ways” may mean in particular that the first measured variable experiences a different change than the second measured variable, if the state of the sensor element changes, for example, if the sensor element is soiled more strongly, in particular in comparison to a new condition.

For example, in the method according to the present invention, the state of the sensor element may be inferred, in particular in that at least one item of information about the state is generated. This may be understood to mean, for example, that the state of the sensor element and/or items of information about the state of the sensor element may be inferred from empirical values and/or simulations and/or known earlier measurement series.

The correction may be formed and/or determined and/or generated, for example, by at least one comparison between the first measured variable and the second measured variable. The comparison may be an arithmetic operation, in particular at least one subtraction and/or at least one addition and/or at least one division and/or at least one multiplication. For example, the comparison may be at least one comparison of maximum points and/or at least one comparison of individual measured values and/or at least one comparison of measurement series and/or at least one comparison of two slopes of the measurement series, in particular of the first measured variable and the second measured variable. In the simplest case, the comparison may be a comparison of the first measured variable and the second measured variable, it being able to be established whether the first measured variable and the second measured variable coincide or whether the first measured variable and the second measured variable do not coincide.

The first measured variable and/or the second measured variable may be selected, in particular independently of one another, from the group including: a heating voltage, which is required to set a predefined temperature of the heating element, of a heating resistor of the heating element; a heating current, which is required to set a predefined temperature of the heating element, through a heating resistor of the heating element; a heat output, which is required to set a predefined temperature of the heating element, of a heating resistor of the heating element; a temperature difference between temperatures detected using the temperature measuring sensors. “Selected independently of one another” may be understood in particular to mean that the first measured variable is a different measured variable than the second measured variable.

The predefined temperature of the heating element may be regulated, for example, by measuring the temperature of the heating element, for example, via the internal resistance of the heating element and/or by at least one temperature measuring sensor on the heating element.

The flow property may be a mass flow rate and/or a volume flow rate. The mass flow rate may be a variable, for example, which may be detected in a unit [mass]/[cross-sectional area]/[time]. Thus, this may be in particular a mass of the flowing fluid medium which flows per unit of time through a cross section, the cross section being a cross section of an intake pipe in a motor vehicle, for example. The volume flow rate may be, for example, a physical measured variable, which may be detected in a unit [volume]/[cross-sectional area]/[time]. The volume flow rate may be in particular a volume of the fluid medium which flows per unit of time through a cross section, for example, through a cross-sectional area of an intake system and/or a pipe in general.

In the determination of the flow property, the first measured variable and the second measured variable may each be taken into consideration using different weightings, in particular in the correction. This may be understood to mean, for example, that initially a mean value may be determined, in particular having different weighting of the first measured variable in comparison to the second measured variable. In particular, the weighting may be a prefactor, which may be known from simulations and/or empirical values and/or calibrations, for example. For example, a geometric mean, in particular using different weighting of the first measured variable and the second measured variable, may be formed from the first measured variable and the second measured variable. In particular, a weighted geometric mean value and/or a weighted arithmetic mean value may be formed. In general, the expression “using different weightings” may mean that a new variable is determined from an arithmetic operation from the first measured variable and the second measured variable, the value of the new variable being able to be determined to different degrees, in particular not equivalently, by the first measured variable and the second measured variable.

For example, at least one correction factor may be determined from the first measured variable and the second measured variable. The correction factor may be a numeric value, for example, a dimensionless numeric value, which may be multiplied by the first measured variable and/or by the second measured variable and/or by the new variable, for example. The result may be the flow property, for example, this flow property may come closer to the real value of the flow property than the first measured variable and/or the second measured variable. The real value may be in particular a value which specifies the flow property, which may be without measuring errors, in particular without systematic measuring errors. The flow property, in particular a corrected flow property, may be determined in particular with the aid of at least one predefined relation from one of the measured variables, for example, the first measured variable or the second measured variable, as an uncorrected flow property. The corrected flow property may be a value for the flow property which is closer to the real value than the uncorrected flow property, for example, the first measured variable and/or the second measured variable. The relation may be, for example, a mathematical relationship and/or an assignment, for example, an assignment of table values, for example, from at least one simulation and/or from at least one empirical value. The relation may take into consideration, for example, at least one calibration, which may be carried out in the new condition of the sensor element, for example.

The uncorrected flow property may be in particular the first measured variable and/or the second measured variable and/or the mean value, in particular using different weighting, and/or the weighted geometric mean value and/or the weighted arithmetic mean value. The uncorrected flow property may be multiplied by the correction factor, in particular as a correction, for example. In principle, the uncorrected flow property may also be multiplied by multiple correction factors and/or divided by multiple correction factors. The uncorrected flow property may be multiplied by the correction factor and/or divided thereby to determine the flow property more precisely and/or in a more error-free way, in particular to determine the most real possible flow property, in particular the real value.

The flow property may be determined, for example, with the aid of at least one predefined relation, for example, known from the calibration and/or from at least one simulation, from one of the measured variables, for example, from the first measured variable and/or from the second measured variable and/or a mean value of the first measured variable and the second measured variable, for example, using the weighting, as the uncorrected flow property.

For example, the uncorrected flow property may be multiplied and/or divided by at least one function value of a correction function and/or a correction vector. The correction function may be, for example, a function and/or relation, which assigns at least one function value in each case to at least one flow property, which may be a plurality of flow properties. The correction function may be in particular at least one correction vector and/or at least one correction matrix and/or at least one continuous and/or discontinuous function. The function value may be dependent on the flow property. The function value may be a value, for example, which may be read off from a table, which may be in the case of a known uncorrected flow property, and/or may be calculated with the aid of a function, for example, a mathematical function, and/or may be generated by a simulation from an uncorrected measured value.

To select the function value of the correction function, the uncorrected flow property may be assumed. In principle, the uncorrected flow property may be the first measured variable or the second measured variable or a weighted mean value of the first measured variable and the second measured variable or a measured variable, which may be calculated from the first measured variable and the second measured variable.

In another aspect of the present invention, a device is provided for detecting at least one flow property of a flowing fluid medium, the device having at least one sensor element, for example, a sensor element as described above. The sensor element may be, for example, an HFM sensor chip. The sensor element includes at least one heating element and at least two temperature measuring sensors. Furthermore, the device has at least one activation unit, the activation unit being configured to carry out a method as described in one of the preceding descriptions.

The sensor element may be, for example, a sensor element as is discussed in the related art, for example, in Robert Bosch GmbH: Sensoren im Kraftfahrzeug [Sensors in Motor Vehicles], first edition 2010, pages 146 through 149. In principle, however, it also may be another sensor element. The sensor element may be connected with the aid of at least one electrical connection to the activation unit, for example, an activation and analysis circuit. The sensor element may be understood in general as an element which is configured to detect the at least one flow property of the flowing fluid medium, for example, detect it qualitatively and/or quantitatively and/or convert it into suitable measured values, for example, into the first measured variable and/or the second measured variable, for example, as described above, which may be into electrical and/or optical signals. In particular, the sensor element may include at least one sensor chip which may be brought into contact with the flowing fluid medium. For example, the sensor element may include at least one sensor chip having a measuring surface, for example, the heating element, for example, at least one heating resistor, and the at least two temperature measuring sensors, for example, at least two temperature measuring resistors being able to be situated on the measuring surface. A mass flow rate and/or volume flow rate and/or a speed of the fluid medium may be inferred from an asymmetry of the temperature distribution, for example, the measuring signals of the temperature sensors. In particular, a measured value, for example, the first measured variable and/or the second measured variable, may be inferred as described above, for example.

Alternatively or additionally, the sensor element may also include other types of sensor elements, for example, at least one temperature sensor, in particular a temperature sensor for regulating the heating element, and/or at least one pressure sensor and/or other types of sensor elements, which fundamentally may be provided from the related art. The sensor element may be accommodated in particular in the device in such a way that it is directly or indirectly in contact with the flowing fluid medium. For example, the sensor element may be accommodated directly in a flow pipe, through which the fluid medium may flow at least partially. Alternatively, the device may also be entirely or partially configured as a plug-in sensor, for example, which has a housing, which may be introduced into the flowing fluid medium, for example, permanently or replaceably. Thus, for example, the device may include a flow pipe and/or may interact with a flow pipe, into which the plug-in sensor may protrude, so that the plug-in sensor protrudes into the flow cross section of the flow pipe. At least one channel may be accommodated in the plug-in sensor, for example, as in the case of available hot-film air flow meters, through which at least one part of the fluid medium may flow. For example, the plug-in sensor may include at least one inlet opening, through which a part of the fluid medium may be conducted into the channel, and/or at least one outlet opening, through which an outflow out of the channel may be possible. The channel may be configured in particular as branched and may include at least one main channel, for example, through which a part of the fluid medium flows, and also at least one bypass channel, for example, through which a volume fraction of the fluid medium, which is branched off from the main channel, may flow, for example. The sensor element may be situated in at least one channel, in particular in the bypass channel, for example, in that the fluid medium flows over a measuring surface of the sensor element, for example, the sensor chip. Reference may be made in this regard in principle to the above-mentioned related art.

The activation unit, for example, an activation and/or analysis circuit, may fundamentally be understood as an arbitrary electrical and/or electronic circuit, which is configured to activate the sensor element for a measurement and/or to record at least one measuring signal, for example, the first measured variable and/or the second measured variable, of the sensor element and may carry out the method according to the present invention. For example, the activation unit may be a circuit which supplies the sensor element with at least one voltage and/or at least one current, which is required for the method according to the present invention, for example. Alternatively or additionally, however, the activation unit may also include at least one measuring signal recorder, however, with the aid of which at least one measuring signal of the sensor element, for example, the first measured variable and/or the second measured variable, may be detected. In addition, the activation unit may include elements, which may be used for signal processing and/or signal preprocessing, for example. Thus, for example, the correction may be at least partially carried out in the activation unit, for example, in conjunction with digitization of measuring signals, for example, the first measured variable and/or the second measured variable. The activation unit may accordingly include one or more electronic components, for example, at least one amplifier and/or at least one analog-digital converter, and/or at least one storage element, for example, the memory, and/or at least one data processing device. In particular, the activation unit may include arbitrary combinations of the mentioned elements and/or other elements. The activation unit may also be accommodated, like the sensor element, in a plug-in sensor, for example, in an electronics chamber of a plug-in sensor, for example, which may be spatially separated from the above-described channel.

The electrical connection between the sensor element, for example, the sensor chip, and the activation unit may fundamentally be an arbitrary connection, which is configured to transport electrical signals, in particular voltages and/or currents and/or supply voltages or supply currents, respectively. In particular, the electrical connection may include at least one wired connection, with the aid of which, for example, at least one terminal contact, for example, at least one terminal pad of the activation unit may be connected to at least one terminal contact, for example, at least one terminal pad of the sensor element. Such bonding techniques are believed to be fundamentally understood by those skilled in the art. For example, thin-wire bonding techniques and/or other bonding techniques may be used.

The provided method and the provided device may have a variety of advantages in relation to available methods and devices of the type mentioned. One advantage of the method may be, for example, that no additional structures are required on a surface of the sensor element, for example, the sensor chip, in particular as is believed to be understood from the related art, since the method according to the present invention, for example, for a determination of the air mass from a heater signal, for example, from the heating voltage and/or from the heat output, may only require an adaptation of the signal processing, in particular an adaptation of the activation unit, in comparison to available sensor devices and/or methods from the related art.

The determination of an air mass from the heater signal may sensitively react to resistance drifts. Therefore, a determination and/or detection from the heater signal may not have as much long-term stability as a method for analyzing temperature differences, as is believed to be understood from the related art, for example. For example, a flow direction generally may not be derived from the heater signal. To correct an air mass signal, in particular according to the method provided according to the present invention, a precision of a heater analysis, in particular a detection with the aid of the heater signal, may be sufficient in the case of large and/or contamination-related deviations, however. In particular a detection and/or compensation of a contamination-related drift may be made possible by the provided method and/or the provided device, in particular by comparing different measured variables derived from the same sensor element, for example, a supplied heat output versus a temperature distribution on the sensor.

The method according to the present invention may be used for measuring the intake air in motor vehicles, for example, in all thermal air flow meters from the related art, which may be in thermal air flow meters which include a sensor element based on micromechanical technologies. The application may be combined with other sensor elements, for example. An application with other sensor elements is therefore not excluded in principle, but may be significantly more complex, for example.

It may thus be possible by way of the method according to the present invention and the device according to the present invention, in particular by way of the comparison of various analysis methods, in particular of the first measured variable and the second measured variable, to draw conclusions about a type and/or intensity of the soiling and/or to take compensatory measures to correct an air mass signal, for example, of the first measured variable and/or the second measured variable.

Exemplary embodiments of the present invention are shown in the drawings and are explained in greater detail hereafter.

### BRIEF DESCRIPTION OF THE DRAWINGS

FIG. 1 shows an exemplary embodiment of a device according to the present invention as a perspective view having an illustration of a sensor element in enlargement and an illustration of a part of the method according to the present invention.

FIG. 2 shows a view of four different first measured variables according to the method according to the present invention for different degrees of soiling.

FIG. 3 shows a view of four different second measured variables according to the method according to the present invention for the four different degrees of soiling.

FIG. 4 shows a view of the method according to the present invention.

### DETAILED DESCRIPTION

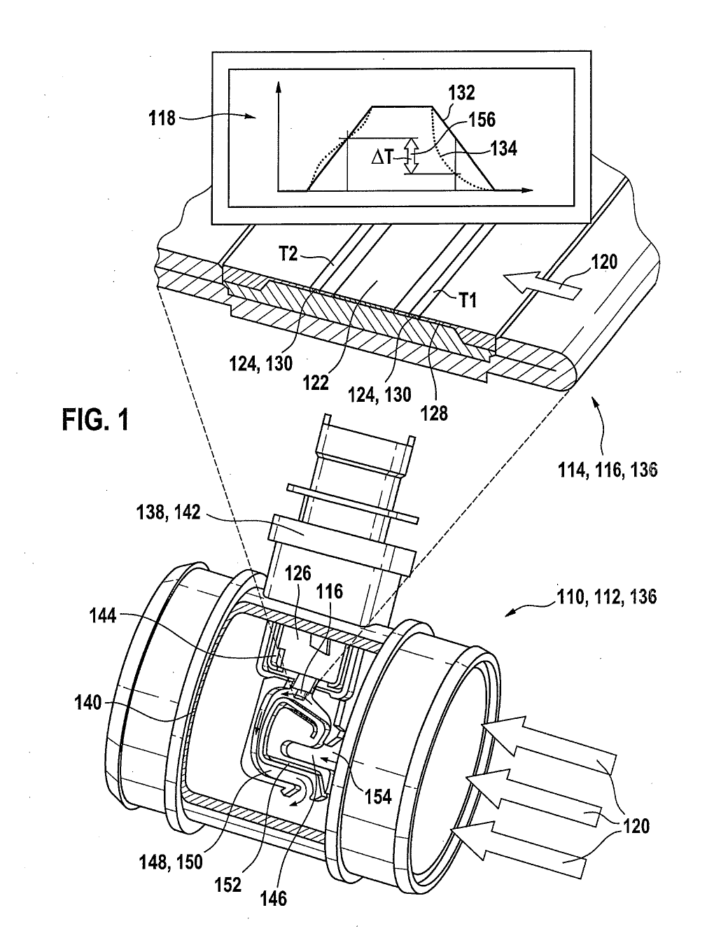

FIG. 1 shows a perspective view 110 of an exemplary embodiment according to the present invention of a device 112 and an enlarged view 114 of a sensor element 116 according to the present invention and a part of a measuring principle 118 of the method according to the present invention.

In the method according to the present invention for detecting at least one flow property of a flowing fluid medium 120, shown in FIG. 1 by arrows, for example, which may indicate the flow direction, at least one sensor element 116 is used. Sensor element 116 includes at least one heating element 122, which may be configured as a heating zone, for example, and at least two temperature measuring sensors 124. Device 112 according to the present invention for detecting the at least one flow property of flowing fluid medium 120 has, in addition to the at least one sensor element 116, which includes at least one heating element 122 and at least two temperature measuring sensors 124, furthermore at least one activation unit 126. Activation unit 126 is configured to carry out the method according to the present invention.

For example, various temperature-sensitive resistors 130, for example, the two temperature measuring sensors 124, may be seated on a diaphragm 128, in particular a thin diaphragm 128. A resistor may be operated as a heater, in particular as a heating element 122, in the center of diaphragm 128, for example. With the aid of this heating element 122, for example, an excess temperature in relation to the surroundings may be set, for example. Resistors 130 in areas upstream, in particular for a measurement of a temperature T1, and downstream, in particular for measurement of a temperature T2, of heating element 122, in particular the heater, may be operated as temperature sensors 124, for example. The expression “upstream” may indicate in particular a localization remote from heating element 122, in particular a localization before heating element 122 in the flow direction of flowing fluid medium 120. The expression “downstream” may also in particular indicate a localization remote from heating element 122 in this case, in particular a localization after heating element 122 in the flow direction of flowing fluid medium 120. In the method according to the present invention, the flow may be directed against sensor element 116, in particular diaphragm 128. for example. In relation to a state without flow, in which generally a trapezoidal temperature distribution is approximately to be expected, as shown as a solid line 132 in measuring principle 118 in FIG. 1, in a state with flow, in particular an upstream area may be cooled, a downstream area remaining approximately unchanged, as shown in dotted line 134 in measuring principle 118 from FIG. 1. Solid line 132 shows in particular a temperature distribution of the sensor without air flow, dotted lines 134 may show a temperature distribution of sensor element 116 with air flow. In particular, a temperature difference ΔT may arise between temperature measuring sensors 124, in particular between temperatures T1 and T2, for example, as a signal. The temperature difference may be determined in particular with the aid of temperature-sensitive resistors 130, in particular temperature measuring sensors 124.

Device 112 may be configured as a hot-film air flow meter (HFM) 136, which may include a plug-in sensor 138, which may be plugged into a flow pipe 140 of an intake system of an internal combustion engine, for example, as shown in perspective view 110 in FIG. 1. Plug-in sensor 138 may have at least one plug-in sensor housing 142 and/or at least one electronics chamber 144 and/or at least one measuring channel chamber 146. A channel structure 148 may be provided in measuring channel chamber 146, for example, having at least one main channel 150 and/or at least one bypass channel 152. Fluid medium 120, for example, air, may flow into channel structure 148 through an inlet opening 154 and may flow through it. Activation unit 126 may furthermore in particular include multiple electronics components.

In the method according to the present invention, which is shown in FIGS. 1 through 4, at least one first measured variable 156 and at least one second measured variable, which is different from first measured variable 156, are detected with the aid of sensor element 116. First measured variable 156 and the second measured variable may be influenced by the flow property. At least one correction, in particular at least one correction factor and/or at least one correction vector, is generated from first measured variable 156 and the second measured variable. The flow property is determined from first measured variable 156 and the second measured variable under consideration of the correction.

For example, a resistance difference, in particular between resistors 130, in particular between temperature measuring sensors 124, and/or a temperature difference ΔT corresponding thereto between the two temperature measuring sensors 124 may be used as first measured variable 156 and/or as an air mass signal, in particular with the aid of corresponding analysis circuits, in particular activation unit 126. For example, a heat output, which is necessary to keep the heater, in particular heating element 122, at a defined temperature may be used as a second measured variable or alternatively as first measured variable 156 and/or as a measuring signal for the air mass.

Speaking generally, it is possible to detect temperatures at various points of diaphragm 128 and/or to set defined temperatures using heaters, in particular using heating element 122. These temperatures and/or temperature differences and/or heating voltages may be used, for example, as first measured variable 156 or as the second measured variable for determining an air mass signal, in particular the flow property.

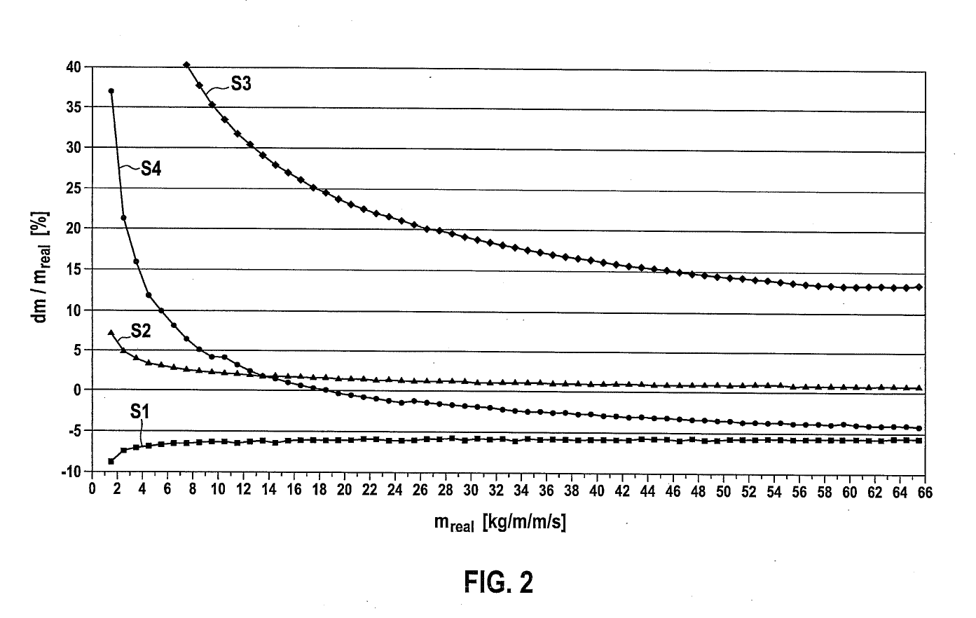

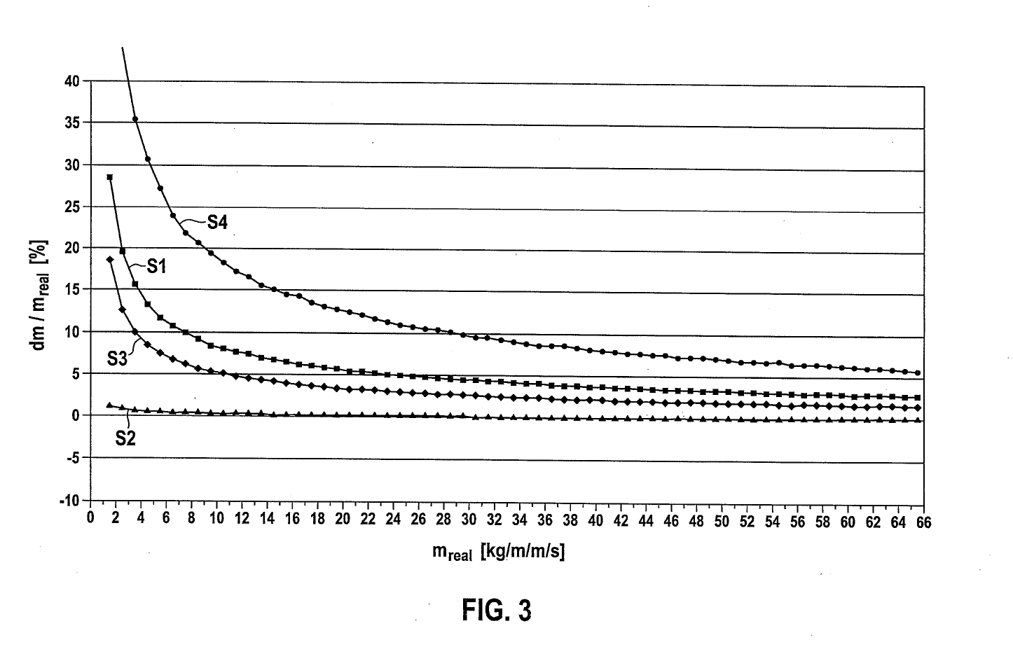

A change of a state of sensor element 116 may influence first measured variable 156 and the second measured variable, which may be in different ways. The state and/or the change of the state may be in particular a contamination of sensor element 116, in particular diaphragm 128, for example. For example, if diaphragm 128 is contaminated, this may result in a corruption of the measuring signal depending on the location of a dirt deposit, in particular a corruption of first measured variable 156 and/or the second measured variable. An extent and a form of the corruption may essentially be determined by the method of the analysis, i.e., for example, temperature difference ΔT of the heating sensor, for example, temperature measuring sensor 124, versus the power demand of the heater, for example, of heating element 122. FIGS. 2 and 3 show examples of studies in particular using device 112 according to the present invention, in particular using sensor element 116.

FIG. 2 shows in particular a characteristic curve error in the case of various types of soiling, in particular in the case of four different types of soiling, during a standard analysis, for example, during analysis of temperature difference ΔT, in particular of first measured variable 156, for example, measured by temperature measuring sensor 124. The characteristic curve error may be in particular a deviation between first measured variable 156, for example, temperature difference ΔT, in relation to a real flow property. The characteristic curve error is in particular shown in this case in percent on the y axis as a difference of an air mass dm in comparison to a real air mass mᵣₑₐₗ, which may be as a real value. On the x axis, in particular an air mass, in particular a real air mass, which may be an area-specific air mass mᵣₑₐₗ, is shown in kilograms/meters/meters/seconds, in particular in a range from an idle up to a full load range. FIG. 2 in particular relates to a calculated air mass deviation, in particular a calculated characteristic curve error. For example, various forms of the soiling and/or contamination are considered, expressed by four different lines in FIG. 2 and FIG. 3:
S1: uniform soiling of diaphragm 128, in particular having a thickness of the soiling of 1 μm;
S2: diaphragm 128, which is only soiled on the inflow side, in particular upstream, in particular soiled 1 μm thick, which may be linearly decreasing over 10% of diaphragm 128;
S3: diaphragm 128, which is only soiled on the inflow side, in particular upstream, in particular soiled 5 μm thick, which may be linearly decreasing over 20% of diaphragm 128; and
S4: diaphragm 128, which is soiled on the inflow side, in particular upstream, in particular is soiled 5 μm thick, which may be linearly decreasing over 20% of diaphragm 128, the remainder of diaphragm 128 being soiled 2 μm thick in particular.

The dirt layer may have a heat conduction of 0.3 W/m/K, for example. FIG. 3 shows in particular characteristic curve error dm/mᵣₑₐₗ in percent in the case of various types of soiling, in particular for cases S1 through S4, as described above, in the analysis of a heater voltage, for example, as the second measured variable. On the x axis, a real air mass mᵣₑₐₗ is also specified in kilograms/meters/meters/seconds. FIG. 2 therefore shows in particular an analysis, as may also be used conventionally, for example, a variant of an analysis being shown in FIG. 3, in which a voltage for regulating a heating zone, for example, of heating element 122, is analyzed. These two different analyses, in particular of different measured variables, which may be first measured variable 156 and the second measured variable, as shown in FIGS. 2 and 3, may be compared to one another. The cases shown in FIGS. 2 and 3 were calculated in particular with the aid of a simulation program under consideration of a heat conduction of diaphragm 128 and a heat dissipation to the flow, in particular to fluid medium 120. FIG. 2 shows the characteristic curve deviation in the case of standard analysis and FIG. 3 shows the analysis of the heater voltage. It is clear in FIGS. 2 and 3 in particular that air masses mᵣₑₐₗ, in particular deviations dm/mᵣₑₐₗ, which are indicated in the particular cases, in particular in the case of the particular measured variables, in particular first measured variable 156 and the second measured variable, may differ. For example, if the air mass is thus determined by two different methods, for example, an air mass mf from the standard analysis, in particular from the temperature difference, and an air mass mh from the heater analysis, presuming a calibration in the new condition, different air masses may result, with simultaneous or realtime analysis, in the event of soiling. Based thereon, in particular based on the difference, various corrections may be activated, for example, according to the method according to the present invention.

In the method according to the present invention, for example, the state of sensor element 116, in particular the soiling, for example, S1 through S4, may be inferred, in particular in that at least one item of information may be generated about the state, for example, the soiling and/or the contamination. The information may be, for example, the information that sensor element 116 and/or diaphragm 128 is partially or entirely soiled. In particular, for example, the location of the soiling, for example, upstream and/or downstream, and/or a thickness of the soiling may be detected.

The correction may be formed by at least one comparison between first measured variable 156, as is shown, for example, in FIG. 2 for various types of soiling, and the second measured variable, as is shown, for example, in FIG. 3 for various measured variables. A comparison may be at least one arithmetic operation, for example, at least one subtraction and/or at least one addition and/or at least one division and/or at least one multiplication, for example.

First measured variable 156 and/or the second measured variable may be selected independently from one another, for example, from the group including: a heating voltage, which is required to set a predefined temperature of heating element 122, of a heating resistor of heating element 122; a heating current, which is required to set a predefined temperature of heating element 122, of a heating resistor of heating element 122; a heat output, which is required to set a predefined temperature of heating element 122, of a heating resistor of heating element 122; a temperature difference between temperatures detected using temperature measuring sensors 124. In the exemplary embodiment shown in FIGS. 1 through 4, first measured variable 156 is, for example, the temperature difference between temperatures ΔT detected using temperature measuring sensors 124. The second measured variable is in particular a voltage required to set a predefined temperature of heating element 122, for example, between the ends of a heating resistor of heating element 122.

The flow property may be a mass flow rate in the present example in particular. In principle, the flow property may be a mass flow rate and/or a volume flow rate and/or another flow property, for example, or an arbitrary combination of the mentioned or other flow properties.

During the determination of the flow property, first measured variable 156 and the second measured variable may each be considered using different weightings, in particular in the correction. Furthermore, for example, at least one correction factor may be determined from first measured variable 156 and the second measured variable, the flow property being able to be determined, for example, with the aid of at least one predefined relation, for example, known from the calibration, from one of the measured variables as an uncorrected flow property. The uncorrected flow property may be multiplied by the correction factor, for example. In the exemplary embodiment according to the present invention, for example, using the different analysis methods, which may be in the case of at least one determined air mass, for example, mᵣₑₐₗ, the determined air mass also being able to include at least one air mass range, a correction factor kf may be formed, for example, of the form kf=(f*mf +(1−f)*mh)/ms, f being able to be a further factor, for example, which may favorably be between 0 and 1, which may be between 0 and 0.7, for example.

The flow property may be determined with the aid of at least one predefined relation, for example, known from the calibration and/or a simulation, from one of the measured variables, in particular first measured variable 156 and/or the second measured variable, as an uncorrected flow property. The corrected flow property may be multiplied by at least one function value of a correction function 158. Correction function 158 may be in particular at least one correction vector and/or at least one correction matrix and/or at least one continuous function and/or at least one other function. Correction function 158 in particular assigns function values to each of a plurality of flow properties. The function value may be dependent on the flow property. In the illustrated exemplary embodiment, the correction may take place using an air mass-dependent correction vector kv(mᵣₑₐₗ), in particular as a predefined relation and/or correction function 158. In particular, the flow property, in particular the corrected flow property, may be calculated by ms(mᵣₑₐₗ)_{new}=ms(mᵣₑₐₗ)*kv(mᵣₑₐₗ)*kf. In particular the uncorrected flow property, for example, first measured variable 156 and/or the second measured variable, may be assumed for the selection of the function value of correction function 158.

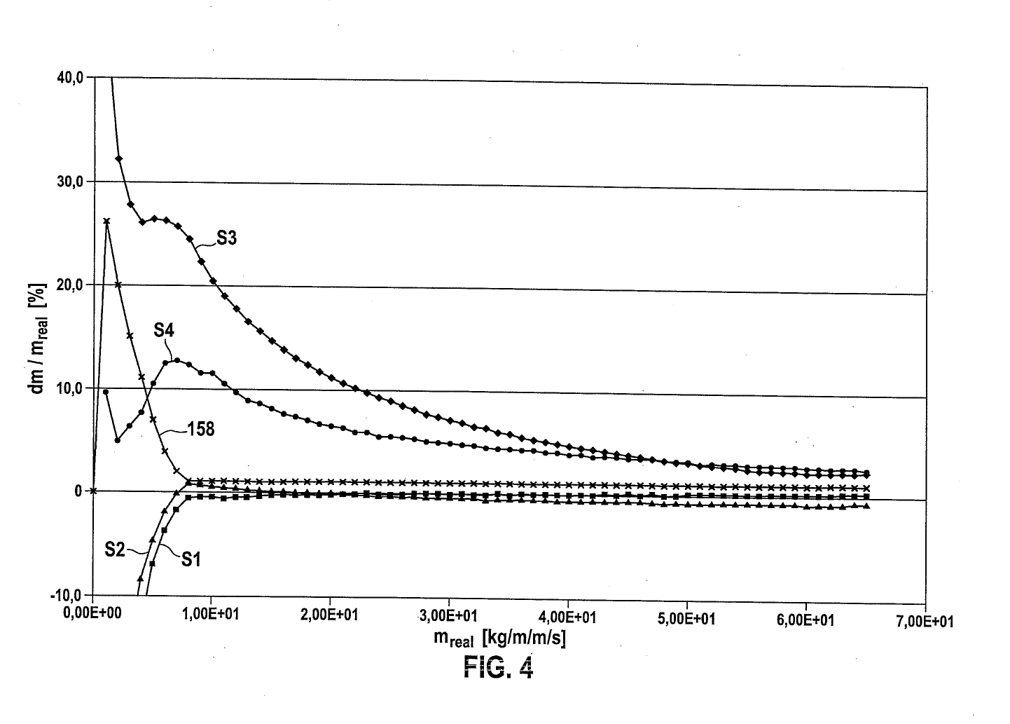

FIG. 4 shows in particular characteristic curve errors in the case of various types of soiling, in particular S1 through S4, having a correction function 158 after application of the correction. In the diagram shown in FIG. 4, in particular dm/mᵣₑₐₗ is shown in percent over the air mass, in particular the real value of air mass mᵣₑₐₗ, in kilograms/meters/meters/seconds. FIG. 4 shows in particular a result of an exemplary embodiment of the method according to the present invention, where f=0.3 and kf is determined in the case of mkorr=36 kilograms/meters/meters/seconds. An improvement is clear in FIG. 4 by way of comparison to the uncorrected air mass signals in the event of contamination, which are shown in FIGS. 2 and 3.

In the method according to the present invention, in particular in a practical application, the correction may be carried out in particular after multiple comparisons of an item of air mass information of a predetermined air mass mkorr, in particular in the event of multiple comparisons of first measured variables 156 to second measured variables.

Device 112 may be calibrated in the new condition. For example, a characteristic curve for first measured variable 156 and a characteristic curve for the second measured variable may be generated in this case. For example, during operation, first measured variable 156 may be compared to the second measured variable, for example, from an analysis of the temperature difference and the heat output. If first measured variable 156 and the second measured variable, in particular the detected flow properties, coincide, for example, the state of sensor element 116 may be inferred, in particular that sensor element 116 is not soiled. If a discrepancy occurs between first measured variable 156 and the second measured variable upon the comparison, a soiling of sensor element 116 may be inferred therefrom, for example, in addition, at least one correction may also be carried out in this case in particular, for example, a recalibration and/or a removal of the soiling.

1-10. (canceled)

11. A method for detecting at least one flow property of a flowing fluid medium, the method comprising:
detecting at least one first measured variable and at least one second measured variable, which is different from the first measured variable, with the aid of at least one sensor element, the sensor element including at least one heating element and at least two temperature measuring sensors, wherein the first measured variable and the second measured variable being influenced by the flow property; and
generating at least one correction, including at least one of at least one one correction factor and at least one correction vector, from the first measured variable and the second measured variable, the flow property being determined from the first measured variable and the second measured variable under consideration of the correction.

12. The method of claim 11, wherein a change of a state of the sensor element influences the first measured variable and the second measured variable in different ways.

13. The method of claim 11, wherein, in the method, the state of the sensor element is inferred, in that at least one item of information about the state is generated.

14. The method of claim 11, wherein the correction is formed by at least one comparison between the first measured variable and the second measured variable.

15. The method of claim 11, wherein at least one of the first measured variable and the second measured variable are selected independently of one another from the following: a heating voltage, which is required to set a predefined temperature of the heating element, of a heating resistor of the heating element; a heating current, which is required to set a predefined temperature of the heating element, through a heating resistor of the heating element; a heat output, which is required to set a predefined temperature of the heating element, of a heating resistor of the heating element; and a temperature difference between temperatures detected using the temperature measuring sensors.

16. The method of claim 11, wherein, in the determination of the flow property, the first measured variable and the second measured variable are each taken into consideration using different weightings, in the correction.

17. The method of claim 11, wherein at least one correction factor is determined from the first measured variable and the second measured variable, the flow property being determined with the aid of at least one predefined relation from one of the measured variables as an uncorrected flow property, the uncorrected flow property being multiplied by the correction factor.

18. The method of claim 11, wherein the flow property is determined with the aid of at least one predefined relation from one of the measured variables as an uncorrected flow property, the uncorrected flow property being multiplied by at least one function value of a correction function, the function value being dependent on the flow property.

19. The method of claim 11, wherein the uncorrected flow property is assumed for the selection of the function value of the correction function.

20. A device for detecting at least one flow property of a flowing fluid medium, comprising:
at least one sensor element, the sensor element including at least one heating element and at least two temperature measuring sensors; and
at least one activation unit configured to detect at least one flow property of a flowing fluid medium, by performing the following:
detecting at least one first measured variable and at least one second measured variable, which is different from the first measured variable, with the aid of at least one sensor element, the sensor element including at least one heating element and at least two temperature measuring sensors, wherein the first measured variable and the second measured variable being influenced by the flow property; and
generating at least one correction, including at least one of at least one one correction factor and at least one correction vector, from the first measured variable and the second measured variable, the flow property being determined from the first measured variable and the second measured variable under consideration of the correction.
